(19) United States
(12) Patent Application Publication
(10) Pub. No.: US 2025/0044818 A1
(43) Pub. Date: Feb. 6, 2025

(54) TEMPERATURE CONTROLLER

(71) Applicant: Zhongshan Chuancheng Precision Electronics Co., Ltd, Zhongshan (CN)

(72) Inventor: Chunwu HE, Zhongshan (CN)

(73) Assignee: Zhongshan Chuancheng Precision Electronics Co., Ltd, Zhongshan (CN)

(21) Appl. No.: 18/533,168

(22) Filed: Dec. 7, 2023

(30) Foreign Application Priority Data
Aug. 2, 2023 (CN) 202322070584.7

(51) Int. Cl. G05D 23/275; H05B 1/02

(52) U.S. Cl. CPC G05D 23/2754; H05B 1/0213; H05B 2203/02

(57) ABSTRACT

A temperature controller is disclosed, including: a mounting body provided with a first electrical connecting terminal and a second electrical connecting terminal, where a contact conductive mechanism and a heating element are arranged in parallel between the first electrical connecting terminal and the second electrical connecting terminal, the contact conductive mechanism includes a static contact assembly arranged at the first electrical connecting terminal and a movable contact assembly arranged at the second electrical connecting terminal, a bimetallic sheet is arranged on the mounting body, and the bimetallic sheet, when being deformed by heat, is capable of driving the movable contact assembly away from the static contact assembly to enable conduction of the heating element.

### CROSS-REFERENCE TO RELATED APPLICATION

This application is based on and claims the benefit of priority from Chinese Patent Application No. 202322070584.7, filed on Aug. 2, 2023, the entirety of which is incorporated by reference herein.

### TECHNICAL FIELD

The present disclosure relates to a temperature controller.

### BACKGROUND

In the related art, when a temperature controller is subjected to high temperature during operation, a bimetallic sheet in the temperature controller may be deformed by heat to drive a movable contact and a static contact to separate, thereby disconnecting the circuit to achieve corresponding protection.

However, when the temperature near the bimetallic sheet drops to a certain value, the bimetallic sheet may return to its original shape causing the movable contact and the static contact to contact each other again, which leads to restart of the electrical appliance. Therefore, in situations where the actual hazard has not been eliminated, the safety of the user's electricity use cannot be guaranteed.

### SUMMARY

The present disclosure aims to solve at least one of the technical problems in the existing technology. Therefore, the present disclosure provides a temperature controller which can keep a movable contact assembly and a static contact assembly separated after a bimetallic sheet is deformed by heat, so as to improve safety of using electricity.

A temperature controller according to the embodiments of the present disclosure, includes a mounting body, where a first electrical connecting terminal and a second electrical connecting terminal are arranged on the mounting body at an interval, and a contact conductive mechanism and a heating element are arranged in parallel between the first electrical connecting terminal and the second electrical connecting terminal, the contact conductive mechanism includes a static contact assembly arranged at the first electrical connecting terminal and a movable contact assembly arranged at the second electrical connecting terminal and in conductive contact with the static contact assembly, a bimetallic sheet is arranged on the mounting body, and the bimetallic sheet, when being deformed by heat, is capable of driving the movable contact assembly away from the static contact assembly to enable conduction of the heating element.

The temperature controller according to the embodiments of the present disclosure at least has the following beneficial effects.

In the above temperature controller, the contact conductive mechanism and the heating element are arranged in parallel between the first electrical connecting terminal and the second electrical connecting terminal. When the bimetallic sheet is deformed by heat, the movable contact assembly can be driven to separate from the static contact assembly, so that a current of a circuit connected with the first electrical connecting terminal and the second electrical connecting terminal passes through the heating element, and heat generated by the heating element keeps the deformation of the bimetallic sheet, thereby preventing the temperature controller from resetting. When a power supply of the circuit is disconnected, the heating element stops heating, the bimetallic sheet recovers elastic deformation, allowing the movable contact assembly and the static contact assembly to contact each other again. Once the power supply is reconnected, the electrical appliance can operate normally again.

In some embodiments of the present disclosure, the static contact assembly includes a first conductive sheet and a static contact arranged on the first conductive sheet, the movable contact assembly includes a second conductive sheet and a movable contact arranged on the second conductive sheet, the second conductive sheet elastically recovers towards the first conductive sheet to make the movable contact abut against the static contact, a driving rod is movably arranged on the mounting body, one end of the driving rod abuts against the bimetallic sheet, and the other end of the driving rod abuts against the second conductive sheet to drive the movable contact to separate from the static contact.

In some embodiments of the present disclosure, the second conductive sheet is horizontally “U”-shaped, the movable contact is arranged at one end of the second conductive sheet close to the first conductive sheet, and the other end of the second conductive sheet is electrically connected with the second electrical connecting terminal through a conductive connecting sheet.

In some embodiments of the present disclosure, the first electrical connecting terminal is provided with a first vertical conductive part extending upwards and the second electrical connecting terminal is provided with a second vertical conductive part extending upwards, an upper end of the first vertical conductive part is located above an upper end of the second vertical conductive part, both the first conductive sheet and the second conductive sheet are horizontally arranged, one end of the first conductive sheet is connected with an upper part of the first vertical conductive part, the heating element is connected between the other end of the first conductive sheet and the upper end of the second vertical conductive part, the second conductive sheet is connected to the second vertical conductive part and extends below the first conductive sheet, the static contact is convexly arranged on a lower surface of the first conductive sheet, and the movable contact is convexly arranged on an upper surface of the second conductive sheet to abut against the static contact.

In some embodiments of the present disclosure, the bimetallic sheet is horizontally arranged above the first conductive sheet, the first conductive sheet is provided with a guide perforation along a vertical direction, the driving rod slides through the guide perforation along the vertical direction, an upper end of the driving rod abuts against a lower surface of the bimetallic sheet, and the upper surface of the second conductive sheet is provided with a convex hull part abutting against a lower end of the driving rod.

In some embodiments of the present disclosure, the heating element has a cuboid shape, a lower end face of the heating element abuts against the upper end of the second vertical conductive part, one side surface of the heating element abuts against one end of the first conductive sheet far away from the first vertical conductive part, and the first vertical conductive part is provided with a limiting pressing plate which leans downward against an upper end face of the heating element.

In some embodiments of the present disclosure, one end of the limiting pressing plate is provided with two mounting perforations, the first vertical conductive part is provided with two plug-in posts which respectively pass through the corresponding mounting perforations and are in tight fit with the mounting perforations, and a lower surface of the other end of the limiting pressing plate is provided with a plurality of protrusions which leans downward against an upper end surface of the heating element.

In some embodiments of the present disclosure, the limiting pressing plate is made of a conductive material, and the limiting pressing plate is capable of being elastically deformed to make one end of the limiting pressing plate far away from the first vertical conductive part lean downward against the heating element.

In some embodiments of the present disclosure, the mounting body includes a shell and a face cover, an interior of the shell is provided with a containing cavity with an upward opening, the face cover is configured for closing the opening of the containing cavity, the heating element, the static contact assembly, the movable contact assembly and the bimetallic sheet are all located in the accommodating cavity, an inner peripheral wall of an upper end of the shell is provided with a positioning groove, an peripheral edge of the bimetallic sheet abuts against a bottom wall of the positioning groove, and a middle part of the bimetallic sheet abuts against an inner top wall of the face cover.

In some embodiments of the present disclosure, the heating element is a PTC heating unit.

The additional aspects and advantages of the present disclosure will be given in part in the following description, and will become apparent in part from the following description, or will be learned through the practice of the present disclosure.

### BRIEF DESCRIPTION OF THE DRAWINGS

The above and/or additional aspects and advantages of the present disclosure will be more apparent from the following description of the embodiments in conjunction with the drawings, where:

FIG. 1 is an exploded structural diagram of a temperature controller according to an embodiment of the present disclosure;

FIG. 2 is a schematic structural diagram of the temperature controller according to the present disclosure with a mounting body removed;

FIG. 3 is a cross-sectional schematic diagram showing an interior of the temperature controller according to an embodiment of the present disclosure; and

FIG. 4 is a schematic structural diagram of a static contact assembly, a movable contact assembly and a limiting pressing plate of FIG. 2.

### DETAILED DESCRIPTION

The embodiments of the present disclosure will be described in detail hereinafter. Examples of the embodiments are shown in the drawings. The same or similar reference numerals throughout the drawings denote the same or similar elements or elements having the same or similar functions. The embodiments described below by reference to the drawings are exemplary and are intended only to explain the present disclosure and are not to be construed as limiting the present disclosure.

In the description of the present disclosure, it should be understood that the orientation or positional relationship indicated by the terms “up”, “down”, “front”, “back”, “left”, “right”, “vertical”, “horizontal”, “top”, “bottom”, “inside”, “outside” and the like, is based on the orientation or positional relationship shown in the drawings, only for the convenience of describing the present disclosure and simplifying the description, rather than indicate or imply that the indicated device or element must have a specific orientation, or be constructed and operated in a specific orientation. Therefore, the terms should not be construed as limiting the present disclosure.

In the description of the present disclosure, the meaning of several refers to be one or more, and the meaning of multiple refers to be two or more, the meanings of greater than, less than, more than, etc., are understood as not including the following number, while the meanings of above, below, within, etc., are understood as including the following number. If first and second are described, the descriptions are used for the purpose of distinguishing the technical features only, and cannot be understood as indicating or implying relative importance, or implicitly indicating the number of technical features indicated thereby, or implicitly indicating the order of technical features indicated thereby.

In the description of the present disclosure, it should be noted that unless expressly stipulated and defined otherwise, terms such as “installation”, “connected”, “connection”, and the like, should be understood broadly, for example, the connection may be fixed connection, or detachable connection or integral connection; may be mechanical connection, and may also be electrical connection; and may be direct connection, may also be indirect connection through an intermediate medium, and may also be internal communication of two elements. The specific meaning of the above terms in the present disclosure can be understood in a specific case by those of ordinary skills in the art.

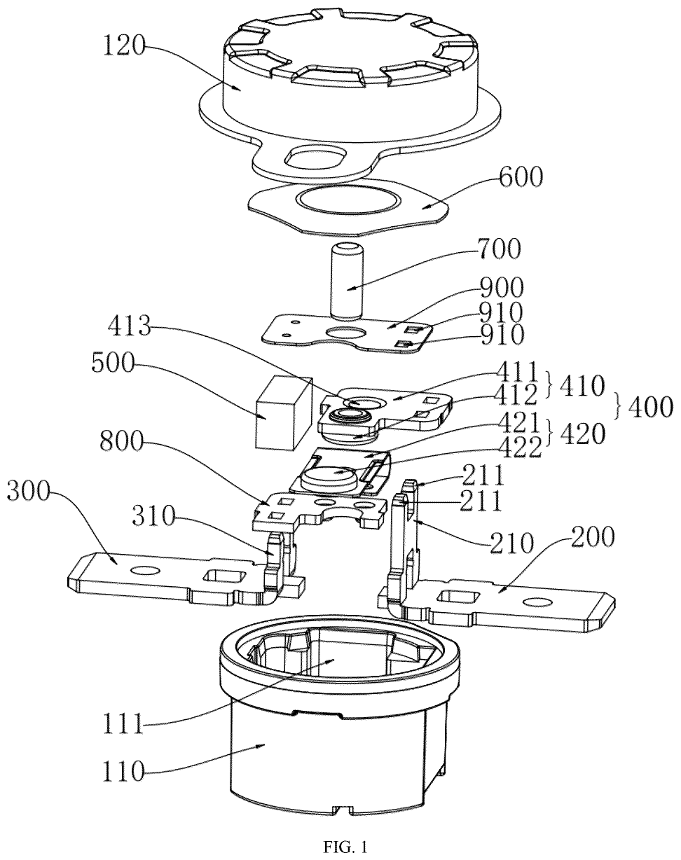

Referring to FIG. 1 to FIG. 4, a temperature controller according to the present disclosure includes a mounting body 100, where a first electrical connecting terminal 200 and a second electrical connecting terminal 300 are arranged on the mounting body 100 at an interval, and a contact conductive mechanism 400 and a heating element 500 are arranged in parallel between the first electrical connecting terminal 200 and the second electrical connecting terminal 300. The contact conductive mechanism 400 includes a static contact assembly 410 arranged at the first electrical connecting terminal 200, and a movable contact assembly 420 arranged at the second electrical connecting terminal 300 and in conductive contact with the static contact assembly 410. A bimetallic sheet 600 is arranged on the mounting body 100, and the bimetallic sheet 600, when being deformed by heat, is capable of driving the movable contact assembly 420 away from the static contact assembly 410 to enable conduction of the heating element 500.

In the above temperature controller, the contact conductive mechanism 400 and the heating element 500 are arranged in parallel between the first electrical connecting terminal 200 and the second electrical connecting terminal 300. When the bimetallic sheet 600 is deformed by heat, the movable contact assembly 420 can be driven to separate from the static contact assembly 410, so that a current of a circuit connected with the first electrical connecting terminal 200 and the second electrical connecting terminal 300 passes through the heating element 500, and heat generated by the heating element 500 keeps the deformation of the bimetallic sheet 600, thereby preventing the temperature controller from resetting. When a power supply of the circuit is disconnected, the heating element 500 stops heating, the bimetallic sheet 600 recovers elastic deformation, allowing the movable contact assembly 420 and the static contact assembly 410 to contact each other again. Once the power supply is reconnected, the electrical appliance can operate normally again.

Secondly, it should be noted that after the heating element 500 is removed, the temperature controller may act as an ordinary temperature controller that can be automatically reset, and can be elastically recovered to close the circuit of the electrical appliance after a temperature of the bimetallic sheet 600 is reduced to a preset value.

It should be noted that the heating element 500 has a resistance value much larger than that of the electrical appliance. When the current in the circuit passes through the contact conductive mechanism 400 and the heating element 500 in parallel, the current selectively passes through the contact conductive mechanism 400 with almost zero resistance, and the electrical appliance can operate normally in this case. When the temperature of the temperature controller is abnormal, the bimetallic sheet 600 deforms to drive the movable contact assembly 420 to separate from the static contact assembly 410, and the current in the circuit passes through the electrical appliance and the heating element 500 connected in series. Because of the large resistance of the heating element 500, the current passing through the electrical appliance is extremely small, and the electrical appliance stops operating. In addition, a user can disconnect the circuit by manually unplugging a power supply, which stops the heating element 500 from generating heat, and the circuit can be connected and disconnected by controlling a solenoid valve switch through a delay module.

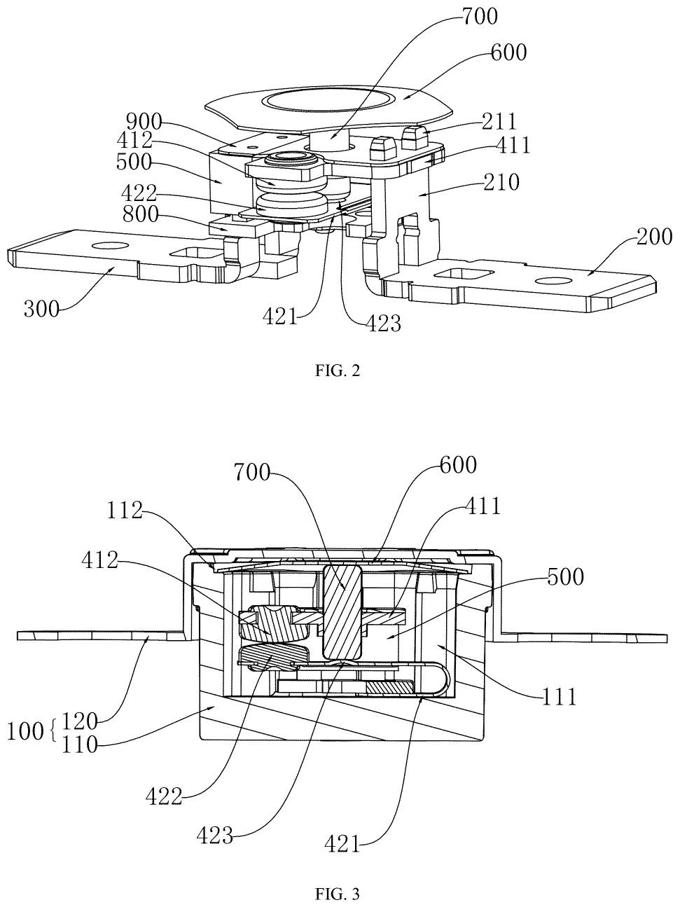

Referring to FIG. 2, in some embodiments of the present disclosure, the static contact assembly 410 includes a first conductive sheet 411 and a static contact 412 arranged on the first conductive sheet 411. The movable contact assembly 420 includes a second conductive sheet 421 and a movable contact 422 arranged on the second conductive sheet 421. The second conductive sheet 421 elastically recovers towards the first conductive sheet 411 to make the movable contact 422 abut against the static contact 412. A driving rod 700 is movably arranged on the mounting body 100, one end of the driving rod 700 abuts against the bimetallic sheet 600, and the other end of the driving rod 700 abuts against the second conductive sheet 421 to drive the movable contact 422 to separate from the static contact 412. It should be noted that after the production and assembly of the temperature controller is completed, the second conductive sheet 421 has a preset deformation, and this preset deformation can drive the movable contact 422 to move towards the static contact 412, so that the movable contact 422 and the static contact 412 contact each other to conduct the electrical appliance. When the electrical appliance fails and the current passing through the contact conductive mechanism 400 is too large, the temperature in the temperature controller rises to drive the bimetallic sheet 600 to be deformed by heat. After the bimetallic sheet 600 is deformed, one end of the driving rod 700 is pushed to make the other end of the driving rod 700 to drive the static contact 412 to separate from the movable contact 422. The above temperature controller has simple structure, few parts and flexible layout. Of course, in other embodiments, the bimetallic sheet 600 may also directly abut against the second conductive sheet 421 to drive the movable contact 422 to separate from the static contact 412.

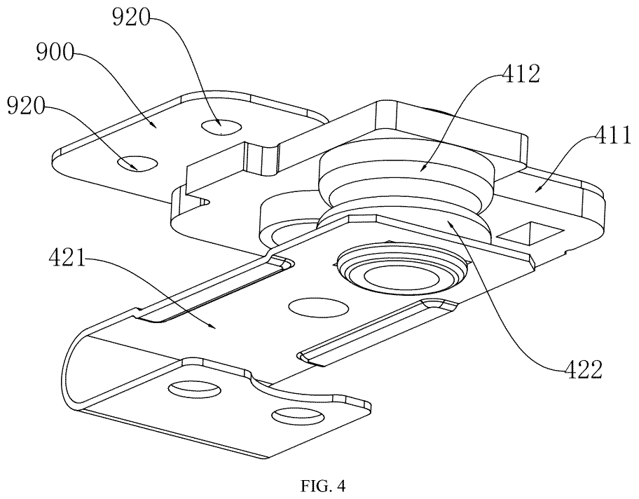

Referring to FIG. 1 and FIG. 3, in some embodiments of the present disclosure, in order to ensure that the pre-deformation of the second conductive sheet 421 is stable enough and that the static contact 412 and the movable contact 422 are kept in contact when the bimetallic sheet 600 is not deformed by heat, the second conductive sheet 421 is horizontally “U”-shaped, and the movable contact 422 is arranged at one end of the second conductive sheet 421 close to the first conductive sheet 411, and the other end of the second conductive sheet is electrically connected with the second electrical connecting terminal 300 through a conductive connecting sheet 800. In this embodiment, the first conductive sheet 411 is located above the second conductive sheet 421, and a height gap between the second conductive sheet 421 and the first conductive sheet 411 is smaller than a height dimension when the movable contact 422 and the static contact 412 are stacked, so that the U-shaped second conductive sheet 421 has a stable pre-deformation.

Referring to FIG. 1 and FIG. 2, in some embodiments of the present disclosure, the first electrical connecting terminal 200 and the second electrical connecting terminal 300 are respectively provided with a first vertical conductive part 210 and a second vertical conductive part 310 extending upwards. An upper end of the first vertical conductive part 210 is located above an upper end of the second vertical conductive part 310, that is, a distance that the first vertical conductive part 210 extends upwards is greater than a distance that the second vertical conductive part 310 extends upwards. Both the first conductive sheet 411 and the second conductive sheet 421 are horizontally arranged. One end of the first conductive sheet is connected with an upper part of the first vertical conductive part 210, the heating element 500 is connected between the other end of the first conductive sheet 411 and the upper end of the second vertical conductive part 310, the second conductive sheet 421 is connected to the second vertical conductive part 310 and extends below the first conductive sheet 411, the static contact 412 is convexly arranged on a lower surface of the first conductive sheet 411, and the movable contact 422 is convexly arranged on an upper surface of the second conductive sheet 421 to abut against the static contact 412. Specifically, the upper end of the first vertical conductive part 210 has two plug-in posts 211 arranged at an interval, and correspondingly, an end part of the first conductive sheet 411 is provided with plug-in holes corresponding to the plug-in posts 211, thus facilitating the assembly between the first conductive sheet 411 and the first electrical connecting terminal 200. Moreover, the structure of the temperature controller with the above layout is highly compact, and the second conductive sheet 421 swings downward with large amplitude when pressed, which improves operating reliability of the temperature controller.

Referring to FIG. 1 and FIG. 2, in some embodiments of the present disclosure, the bimetallic sheet 600 is horizontally arranged above the first conductive sheet 411, the first conductive sheet 411 is provided with a guide perforation 413 along a vertical direction, the driving rod 700 slides through the guide perforation 413 along the vertical direction, an upper end of the driving rod 700 abuts against a lower surface of the bimetallic sheet 600, and the upper surface of the second conductive sheet 421 is provided with a convex hull part 423 abutting against a lower end of the driving rod 700. It can be understood that when the bimetallic sheet 600 is heated, the bimetallic sheet generates downward deformation, thus driving the driving rod 700 to move downwards, and the driving rod 700 abuts against the convex hull part 423 to push the second conductive sheet 421 to generate downward swing deformation, so that the movable contact 422 is separated from the static contact 412. The layout of the temperature controller with the above structure is reasonable, and the bimetallic sheet 600 will not interfere with the contact conductive mechanism 400 when deformed.

Referring to FIG. 2, in some embodiments of the present disclosure, the heating element 500 has a cuboid shape, a lower end face of the heating element 500 abuts against the upper end of the second vertical conductive part 310, one side surface of the heating element 500 abuts against one end of the first conductive sheet 411 far away from the first vertical conductive part 210, and the first vertical conductive part 210 is provided with a limiting pressing plate 900 which leans downward against an upper end face of the heating element 500. It should be noted that the lower end face of the heating element 500 is kept against the upper end of the second vertical conductive part 310 under the action of the limiting pressing plate 900, which prevents the heating element 500 from displacing vertically, and a static friction between the limiting pressing plate 900 and the upper end face of the heating element 500 also prevents the heating element 500 from moving laterally, thus ensuring that the first conductive sheet 411 contacts with the side surface of the heating element 500.

Referring to FIG. 1, FIG. 2 and FIG. 4, in some embodiments of the present disclosure, one end of the limiting pressing plate 900 is provided with two mounting perforations 910, the first vertical conductive part 210 is provided with two plug-in posts 211 which respectively pass through the corresponding mounting perforations 910 and are in tight fit with the mounting perforations 910, thus facilitating the assembly between the limiting pressing plate 900 and the first vertical conductive part 210. A lower surface of the other end of the limiting pressing plate 900 is provided with a plurality of protrusions 920 which leans downward against an upper end surface of the heating element 500, which is beneficial to maintaining multi-point contact between the limiting pressing plate 900 and the heating element 500.

In some embodiments of the present disclosure, the limiting pressing plate 900 is made of a conductive material, and the limiting pressing plate 900 is capable of being elastically deformed to make one end of the limiting pressing plate 900 far away from the first vertical conductive part 210 lean downward against the heating element 500. It can be understood that since the limiting pressing plate 900 is made of the conductive material, even if a side wall of the heating element 500 is separated from the first conductive sheet 411, the limiting pressing plate 900 can also keep the heating element 500 connected between the first electrical connecting terminal 200 and the second electrical connecting terminal 300. Specifically, in this embodiment, the upper end face and the lower end face of the heating element 500 are respectively provided with conductive silver layers, and the heating element 500 is conducted through the limiting pressing plate 900 and the second vertical conductive part 310, while the first conductive sheet 411 and the second vertical conductive part 310 cooperatively support and fix the heating element 500.

Referring to FIG. 1 and FIG. 3, in some embodiments of the present disclosure, the mounting body 100 includes a shell 110 and a face cover 120. An interior of the shell 110 is provided with a containing cavity 111 with an upward opening. The face cover 120 is configured for closing the opening of the containing cavity 111. The heating element 500, the static contact assembly 410, the movable contact assembly 420 and the bimetallic sheet 600 are all located in the accommodating cavity 111. An inner peripheral wall of an upper end of the shell 110 is provided with a positioning groove 112, and a peripheral edge of the bimetallic sheet 600 abuts against a bottom wall of the positioning groove 112. When the temperature does not trigger the bimetallic sheet 600 to deform, a middle part of the bimetallic sheet 600 abuts against an inner top wall of the face cover 120, and when the temperature triggers the bimetallic sheet 600 to deform, the middle part of the bimetallic sheet 600 moves away from the inner top wall of the face cover 120 to push the driving rod 700 to move downwards.

In some embodiments of the present disclosure, the heating element 500 is a PTC (Positive Temperature Coefficient) heating unit. When the temperature exceeds a certain value, a resistance value of the PTC heating element increases step by step with the increase of the temperature, which has the characteristics of high heat exchange efficiency, energy saving, long service life and low cost.

The technical features of the above embodiments can be combined in any way. In order to simplify the description, not all possible combinations of the technical features in the above embodiments are described. However, as long as there is no contradiction in the combinations of these technical features, they should be considered as falling within the scope recorded in this specification.

Although the embodiments of the present disclosure have been shown and described, those of ordinary skills in the art should understand that: various changes, amendments, substitutions and modifications can be made to these embodiments without departing from the principles and purposes of the present disclosure, and the scope of the present disclosure is limited by the claims and equivalents thereof.

What is claimed is:

1. A temperature controller, comprising:
a mounting body, wherein a first electrical connecting terminal and a second electrical connecting terminal are arranged on the mounting body at an interval, a contact conductive mechanism and a heating element are arranged in parallel between the first electrical connecting terminal and the second electrical connecting terminal, the contact conductive mechanism comprises a static contact assembly arranged at the first electrical connecting terminal and a movable contact assembly arranged at the second electrical connecting terminal and in conductive contact with the static contact assembly, a bimetallic sheet is arranged on the mounting body, and the bimetallic sheet, when being deformed by heat, is capable of driving the movable contact assembly away from the static contact assembly to enable conduction of the heating element.

2. The temperature controller according to claim 1, wherein:
the static contact assembly comprises a first conductive sheet and a static contact arranged on the first conductive sheet, the movable contact assembly comprises a second conductive sheet and a movable contact arranged on the second conductive sheet, the second conductive sheet elastically recovers towards the first conductive sheet to make the movable contact abut against the static contact, a driving rod is movably arranged on the mounting body, one end of the driving rod abuts against the bimetallic sheet, and the other end of the driving rod abuts against the second conductive sheet to drive the movable contact to separate from the static contact.

3. The temperature controller according to claim 2, wherein:
the second conductive sheet is horizontally “U”-shaped, the movable contact is arranged at one end of the second conductive sheet close to the first conductive sheet, and the other end of the second conductive sheet is electrically connected with the second electrical connecting terminal through a conductive connecting sheet.

4. The temperature controller according to claim 2, wherein:
the first electrical connecting terminal is provided with a first vertical conductive part extending upwards and the second electrical connecting terminal is provided with a second vertical conductive part extending upwards, an upper end of the first vertical conductive part is located above an upper end of the second vertical conductive part, both the first conductive sheet and the second conductive sheet are horizontally arranged, one end of the first conductive sheet is connected with an upper part of the first vertical conductive part, the heating element is connected between the other end of the first conductive sheet and the upper end of the second vertical conductive part, the second conductive sheet is connected to the second vertical conductive part and extends below the first conductive sheet, the static contact is convexly arranged on a lower surface of the first conductive sheet, and the movable contact is convexly arranged on an upper surface of the second conductive sheet to abut against the static contact.

5. The temperature controller according to claim 4, wherein:
the bimetallic sheet is horizontally arranged above the first conductive sheet, the first conductive sheet is provided with a guide perforation along a vertical direction, the driving rod slides through the guide perforation along the vertical direction, an upper end of the driving rod abuts against a lower surface of the bimetallic sheet, and the upper surface of the second conductive sheet is provided with a convex hull part abutting against a lower end of the driving rod.

6. The temperature controller according to claim 4, wherein:
the heating element has a cuboid shape, a lower end face of the heating element abuts against the upper end of the second vertical conductive part, one side surface of the heating element abuts against one end of the first conductive sheet far away from the first vertical conductive part, and the first vertical conductive part is provided with a limiting pressing plate which leans downward against an upper end face of the heating element.

7. The temperature controller according to claim 6, wherein:
one end of the limiting pressing plate is provided with two mounting perforations, the first vertical conductive part is provided with two plug-in posts which respectively pass through the corresponding mounting perforations and are in tight fit with the mounting perforations, and a lower surface of the other end of the limiting pressing plate is provided with a plurality of protrusions which leans downward against an upper end surface of the heating element.

8. The temperature controller according to claim 6, wherein:
the limiting pressing plate is made of a conductive material, and the limiting pressing plate is capable of being elastically deformed to make one end of the limiting pressing plate far away from the first vertical conductive part lean downward against the heating element.

9. The temperature controller according to claim 1, wherein:
the mounting body comprises a shell and a face cover, an interior of the shell is provided with a containing cavity with an upward opening, the face cover is configured for closing the opening of the containing cavity, the heating element, the static contact assembly, the movable contact assembly and the bimetallic sheet are all located in the accommodating cavity, an inner peripheral wall of an upper end of the shell is provided with a positioning groove, an peripheral edge of the bimetallic sheet abuts against a bottom wall of the positioning groove, and a middle part of the bimetallic sheet abuts against an inner top wall of the face cover.

10. The temperature controller according to claim 1, wherein:
the heating element is a PTC heating unit.
